(19) United States
(12) Patent Application Publication
(10) Pub. No.: US 2017/0099851 A1
(43) Pub. Date: Apr. 13, 2017

(54) METHOD AND DEVICE FOR FORMING ARTISANAL STYLE CHEESE

(71) Applicant: DANIEL LINDGREN, REEDSVILLE, WI (US)

(72) Inventor: DANIEL LINDGREN, REEDSVILLE, WI (US)

(21) Appl. No.: 15/384,315

(22) Filed: Dec. 19, 2016

Related U.S. Application Data
(63) Continuation-in-part of application No. 13/426,397, filed on Mar. 21, 2012.

(51) Int. Cl. A23C 19/09; A01J 25/00

(52) U.S. Cl. CPC A23C 19/09; A01J 25/008

(57) ABSTRACT

An inventive solution directed to a device and method for mass manufacturing artisanal style pasta filata type cheese by concurrently pulling, stretching, molding and cooling to set continuous ribbons of cheese in a brineless environment. The cheese ribbons may further be laminated by secondary segments of said compressional channels.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### CROSS REFERENCE TO RELATED APPLICATIONS

This application is a continuation-in-part of the copending parent application, U.S. patent application Ser. No. 13/426,397, which is incorporated by reference in its entirety herein, and wherein this application claims priority to the parent filing date, Mar. 21, 2012.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark office, patent file or records, but otherwise reserves all copyright rights whatsoever.

### FIELD OF THE INVENTION

The present inventive subject matter relates to the formation of cheese, particularly cheese of the pasta filata type.

### BACKGROUND

According to artisanal hand crafted tradition, the making of pasta filata cheese must follow certain necessary steps to achieve its signature flavor and texture. Texture, in the pasta filata context, provides a tender bounce, elastic and layered quality. Ideal pasta filata texture reflects its physio-chemical composition achieved by proper chemical, heat and physical manipulation of nascent cheese protein and fibers. The ideal flavor of pasta filata cheese by artisanal standards is a sufficient and even salting of the cheese throughout its cross section, without over salting as it is a mild and creamy flavored white cheese with high fat content.

According to artisanal pasta filata cheese making standards, the curd must first reach an ideal pH level of 5.2. Through the development of acid, calcium is removed from the protein structures, allowing formation of the right kind of protein network to begin stretching. The curd is subsequently submersed in a high heat bath for stretching to develop longer strand protein relationships. The high heat bath also assists in partially pasteurizing the nascent cheese curd. The cheese curd must be kept in a heated state during the stretching process to maintain pliability and for protein strands to continue forming while stretched. Some novice techniques call for microwave heating of the curd, which unevenly heats the curd through its crossection. An alternative advanced technique suggested by this same inventor provides for heating of the curd through direct contact with electro conductive means, taking advantage of the curd's even distribution of salt and moisture throughout. The high heat and stretching process at this stage can potentially produce a variety of results depending on the amount of time immersed in the heated bath, the intensity of heat, and the presence or level of salt brine in the hot water bath. Any of these in excess may lead to failed results with denatured or damaged protein strands, loss of fat content or over salting. Ultra-pasteurization is not suggested because over heating will cause natural denaturing of protein molecules and strands.

By traditional methods, stretching occurs when the curd is formed and in a heated pliable state. This is often achieved by submersion of the curd in a heated bath to maintain ideal core temperature. The method of heating the curd by submersion in a hot bath is an archaic method dating to its 14^{th} century Roman origins. This is a simple but timelessly effective technique. By pulling the cheese to stretch in this heated state, oil is preserved in between the strands within protein pockets, giving the cheese is creamy flavor. Stretching of the curd pulls the strands away, creating longer thin strands with space and pockets therebetween which gives the cheese its tender texture. This process has carried on into modern artisanal cheese making methods for its tried and true results.

It is difficult to achieve the high quality standard of artisanal pasta filata cheese in mass manufacturing context due to high volume and time constraints. Natural cheese, particularly of the pasta filata family (including but not limited to mozzarella, provolone, or blends thereof) have plastic or elastic qualities that make it pliable for molding when heated (typically between 120° F. to 160° F.). Pliability in this heated state prevents the cheese from being self supporting (independently hold its own weight and shape). For purposes of packaging cheese with a prescribed shape, specifically pasta filata type cheeses, it is necessary that the external layer of a block be sufficiently cool to hold its own shape and weight while the internal warmer portions be cool enough not to reheat and deform the external layer (otherwise known in the industry as “slumping”). This stage of cooling is called “setting”. Once a piece of cheese has set, it is able to independently maintain a prescribed shape (be “self supporting”) and hence be ready for packaging and shelving. In practice within the manufacturing industry, core setting temperatures for standard pasta filata type cheese have ranged from above 80° F. to below 55° F.

I recently conducted a theoretical transient heat transfer study based on standard cheese physical properties provided by the UW-Madison Diary Center, illustrating its cross sectional temperature profile after 10 minutes of cooling in salt brine solution. For a standard 4×4 inch six pound block of cheese submersed in 32° F. brine solution for 10 minutes, theoretical results reveal the outermost layer reaching an ambient temperature of 32° F. while the inner core temperature remains at approximately 140° F. These numbers reflect actual temperature ranges found in current manufacturing processes under similar conditions. The calculations were based on a 4×4 inch square six pound block of cheese with thermal conductivity of 0.332 W/mK and specific heat of 3 kJ/kgK, theoretically in direct contact with 32° F. brine solution for exactly 10 minutes.

In particular, the theoretical heat study revealed a temperature profile for seven external cross sectional layers (⅝ inch thick each) surrounding a thicker inner core of a 4×4 inch cheese block. The profile shows seven temperature ranges (rounded to the nearest degree) from inner core to outer surface on a per layer basis: 1) 140° F. to 125° F., 2) 125° F. to 109° F., 3) 109° F. to 94° F., 4) 94° F. to 78° F., 5) 78° F. to 63° F., 6) 63° F. to 47° F., 7) 47° F. to 32° F. The outside “skin” (according to the study, being the outermost layer in contact with the external environment) cools relatively quickly given greater surface area exposure to cooling agents. The skin is able to cool from an initial temperature of 140° F. to 32° F. within 10 minutes of submersion in 32° F. brine solution. The interior core, however, experiences negligible temperature change in the same period of time. Typically, the speed of cooling and setting is based in significant part by the thermal conductivity of the cheese, driving overall cooling time. According to this study, the cross sectional outer half of the 4×4 inch cheese mass reaches an average temperature of approximately 66° F. (rounded to the nearest degree) after 10 minutes of submersion in the 32° F. cooling medium while the inner half may require at least 4 to 5 hours or more to reach the same temperature.

Industry standards provide certain dimensional requirements for the manufacture of cheese blocks. One industry standard provides for a 20 pound block of cheese that is 20 inches long, 4.5 inches thick and 8 inches wide. Another standard sized loaf provides for a 5 pound block of cheese that is 4 inches wide, 4.5 inches thick, 10 inches long. Standard manufacturing techniques for the production of large pasta filata type cheese blocks require multiple steps in forming and cooling each block. Typically, these large blocks are shaped in molds and partially cooled to a desirable exterior temperature sufficient to hold shape in suspension. The blocks are then consolidated into a cold brine bath and buoyed through cooling bath channels for up to 12 hours.

This multi-stepped technique of separately forming and cooling the cheese blocks results in substantial loss of time and space as well as loss of inherent desirable qualities within the cheese. Extensive floor space is required to accommodate each separate step of the process. Extensive time (as long as 12 hours depending on the size of the block) is required to set the cheese in liquid cooling medium. The blocks quickly lose their shape when released too soon from their molds and allowed to travel unguided through brining channels. The extensive time submersed in brine solution results in substantial loss of butterfat, uneven salting of the cheese blocks, loss of shape from impact with other surfaces and increased risk of contamination.

The initial steps of forming cheese (stretching and shaping) in manufacture typically involves extrusion of a nascent cheese mass through a screw device, forcing them into molds. The extrusion method tends to excessively work the cheese, cutting into cheese fibers and internal pockets that naturally retain fat, moisture and flavor. This results in loss of flavor, change of texture and decrease in overall mass. The technique goes contrary to suggested methods for forming cheese by those in the art. The best method of stretching and separating cheese is by pulling rather than pushing and pinching rather than cutting, for reasons discussed above. Under current large scale manufacturing processes, the final product tends to be of inferior quality in moisture, flavor, and texture compared to artisanal style crafted pasta filata cheese.

U.S. Pat. No. 5,480,666 attempts to reduce cooling time by providing a method that takes advantage of surface area cooling and the cheese's inherent ability to fuse by lamination. Pasta filata type cheese is first texturized by auger mixing method, then pressed by rollers on a conveyor belt where flattened sheets are cooled directly with a liquid cooling medium. The wide surface area and thinner cross sectional dimensions of each sheet allows it to cool comparatively faster than a block of cheese of standard industry size. Once cooled, the sheets are sliced into ribbons, stacked and allowed to laminate (stacked and fused together into one continuous mass) to produce standard sized blocks. This patent may work fine for processed cheese but the elastic nature of pasta filata cheese is more difficult to manage by this simplistic method. The natural slumping of warm pasta filata type cheese requires cooling within a rigid mold to set the cheese to a defined shape. For this reason, the two-step process of cooling in molds and subsequently in brine baths remains the popular method in mass manufacturing.

U.S. Pat. No. 4,626,439 attempts to improve existing manufacture methods for shaping pasta filata type cheeses. Accordingly, a nascent cheese mass is extruded onto a conveyor belt and pressed by rollers into thin sheets. The sheets are kept warm to maintain pliability during the rolling process. The edges of the sheets are trimmed to desired dimensions and excess pieces are reused. The cheese is kept warm through trimming to preserve excess pieces for reuse. Cooling begins immediately after trimming to quickly set the cheese and to maintain the trimmed dimensions. This process acknowledges the slumping effect of pasta filata cheese and provides an alternative method for shaping. The cooling process in this patent involves immersion of trimmed sheets in cold brine solution. Once set, cheese sheets are ready for slicing, dicing, shredding or cookie cutting. This process does not provide for shaping by mold. There remains a problem of over processing from reuse of trimmed material and decreased flavor and moisture content from over brining.

U.S. Application No. 2009/0226580 A1 similarly extrudes a nascent cheese mass onto a conveyor surface where the mass is pressed and rolled into thin sheets. Alternatively, the sheets are cooled directly on the conveyor with super cooled air and a cooled conveyor surface. This eliminates the need for direct contact with a liquid cooling medium. Since the sheets are directed for immediate comminuting (cut into smaller shapes such as by slicing, dicing or shredding), shape is of no concern. Therefore, the initial step of partial cooling in molds is eliminated and the cooling process is sped up by taking full advantage of surface area cooling. As with the above Pat. No. '580, texturization by extrusion can overwork the cheese and compromise its quality. Exposure to the open-air environment to maximize surface area cooling increases risk of contamination. Lastly, this application does not contemplate actual shaping of the cheese, and therefore renders this application inapplicable to the manufacture of cheese blocks, sticks or other molded forms.

U.S. Pat. No. 4,665,811 provides a method and apparatus similarly as above for pressing a nascent cheese curd to a desired thickness. The purpose of which is to create wider surface area for quick cooling and for final shredding. As with other devices intended solely for comminuting, this device does not provide a method for molding the cheese to shape under careful cooling conditions. Nor does it provide a method for properly texturizing the cheese for a more thoughtful texture since the end purpose of this product is to be eaten in a shredded or heated molten state.

U.S. Pat. No. 4,288,465 provides an alternative method and device for producing pasta filata cheese, specifically narrow strips of cheese of the string cheese type. This method acknowledges the need to stretch the cheese under a certain continuous amount of tension to create longer fiber layers of classic string cheese product. To achieve a continuous stretching affect, this device provides a spool system for directing and winding the cheese throughout. One drawback of this device has to do with slumping effect of warm pasta filata cheese during the stretching phase. In order to properly stretch the nascent cheese mass for producing long fibers and layers, the cheese mass must be in a heated state of approximately 120-140 degrees throughout. In this state, the cheese may be stretched but with very little resisting force beyond its own weight. Therefore, when pulled across a length of space without a means for support, the cheese will naturally drag and slump by gravitational affect. The result of stretching the warm cheese over extensive open space is an uncontrolled variability in thickness and fiber formation along its length as affected by gravity and its own weight due to slumping. As with other spooling methods for creating tension, the slumping problem of this invention may be overcome by providing a greater speed for the front spool, but this could result in secondary problems of even texture control while not completely eliminating the problem of slumping near heated segments. There is also a likely chance of unspooling on portions of the strand affected by slumping. The device in this case does not provide a supporting means between the pipe outlet and the first spool to minimize slumping without reducing the tension effect of the spool. The cheese being concurrently stretched and cooled in this case, will further run into problems of tearing due to the tension exerted on cooled cheese fiber.

U.S. Pat. No. 5,948,459 provides an apparatus and method for forming and cooling flowable cheese matter by forcibly pushing cheese through a molding tube. Therein the cheese is internally cooled by a cooling mechanism externally communicating with the molding tube to selectively create a cooling gradient along the length of the molding tube. According to this invention, pasta filata cheese is moulded and cooled to set in a controlled manner without secondary brining. However, the cheese lacks sufficient and proper texturizing treatment. This device contemplates protein fiber formation primarily from auger and forced extrusion which unfortunately cuts into the natural fiber strands within the cheese mass, compacts the mass and squeezes out fact pockets inside the mass. This device mainly contemplates production of narrow strands of string cheese. Heavier and thicker blocks of cheese will have a difficult time maintain its place along the spool due to slumping affect while affected by greater compaction from its own mass and weight against the molding tube. Therefore, this device would be impractical for mass production of larger sized mozzarella cheese blocks due to compromised quality from increased force needed to push the thicker block through.

Thus, there remains a considerable need for inventive solutions that improves upon the quality and speed of cheese molding and manufacture. All patents and applications referred herein are incorporated by reference in their entirety. Furthermore, where a definition or use of a term in a reference, which is incorporated by reference herein is inconsistent or contrary to the definition of that term provided herein, the definition of that term provided herein applies and the definition of that term in the reference does not apply.

### SUMMARY OF THE INVENTION

An inventive solution directed to the mass manufacturing of artisanal style pasta filata type cheese (including but not limited to mozzarella, provolone and blends thereof) by upholding traditional standards for quality texture, flavor and moisture. The apparatus and method of this invention providing a process whereby Step 1) cheese curd is first texturized in a heated state to form protein fiber strands distinctive to pasta filata cheese, Step 2) the nascent cheese mass is impregnated with seasoning for dry salting, Step 3) the seasoned cheese mass is further texturized in a heated state to evenly mix in seasoning and further form protein strands consistently throughout, Step 4) the nascent and seasoned cheese mass is stretched to form long protein strands and layered texture by engaging with a counter-rotating dual compression belt system which grabs onto and molds the cheese within a compressed cavity while pulling to stretch with a desired level of tension in a heated state, forming long strands and layers of protein structure within the cheese cross section, Step 5) gradually cooling the cheese indirectly by a dry method through thermo-conductive feature of the counter-rotating dual compression belt system along segments of the device that is in contact with an independent external cooling element, Step 6) whereby the cheese is cooled to set and released at a second end of the counter-rotating dual compression belt device for immediate cutting and packaging. The entire process of this invention allows for a completely dry method for seasoning and producing pasta filata cheese for immediate cutting and packaging.

A preferred embodiment of this invention provides the above described steps 1 through 6 wherein the method of heating in stage 2 and 3 is by a dry method wherein the curd is kept in a heated state with direct electric conduction (ohmic heating method), taking advantage of the ionic properties of salt throughout the cheese mass. This process is considered a dry heating method because it does not require submersion in a heated water bath. A dry method of heating allows for dry salting of the cheese at an earlier stage where the salt is able to impregnate and infuse into the cheese mass. While this is a preferred method, it is not required and heating at this early stage 2 and 3 may still be accomplished in a trough containing hot water. The cheese mass once texturized to an ideal level of consistency in Step 3 is then allowed to flow into and be captured by a first open end of a counter-rotating dual compression belt system, directing the cheese towards its second open end.

The counter-rotating dual compression belt system providing a hollow channel space wherein Step 4 provides for the cheese mass to be engaged by the first end of the belt system, capturing and pulling the cheese mass through in a state of tension. The cheese mass is preferably a sufficiently large volume and weight wherein its size and weight provides a slight resistance against the capture and pulling of the counter-rotating dual compression belt system. The elasticity of the cheese adding a slight additional resistance against the pulling but not by much. The slight resistance affect from the composition and size of the cheese mass will provide the necessary level of tension throughout the pulling and molding process. The amount of tension not being too great to risk breaking of fiber strands in cooler segments of the cheese. Also, gravity will not be a factor that would otherwise risk uneven tension along different segments of the cheese, resulting in uneven thickness and texture. The cheese mass is pulled and stretched away from the nascent cheese mass stationed in the hopper of Step 3. Once engaged within the counter-rotating dual compression belt system, the initial segment of the cheese at the first opening end (the proximal end) of the belt system is in a heated state to maximize protein strand formation and layering. This typically follows the first 6 to 12 inches from the first opening end of the belt system. This initial portion of the counter-rotating dual belt device may be in a warmer state to maintain the cheese in pliable state. Alternatively, the internal cavity at this proximal end may be buffered with an insulating flap, keeping this initial segment of the belt temperature neutral if the entire section of belt is cold. By this method, the cheese stays warm and pliable through the initial proximal end of the counter-rotating dual compression belt device where the cheese experiences a compressed pulling effect for approximately 6 to 12 inches, aligning protein molecules into long layered strands. Once through this proximal segment of the device, the cheese is ready for molding and cooling to set.

At this second segment of the belt system, an external cooling channel should be attached to two opposing sides of the belt system to evenly cool the cheese held within while it passes through. The cooling system preferably comprising a cooling liquid channel system where liquid coolant is cycled through, pulling away heat from the belt system and replenishing with new chilled liquid to maintain a continual temperature. This cooling liquid channel system is staged along the length of the belt system in external contact and communication with the belt system to keep the cheese held within in continued cooling state. The temperature of the coolant system may be set at desired level at each segment of the belt system such that the cheese cross section is completely surrounded by a constant temperature. Maintaining the belt at a constant temperature helps improve efficient cooling because every segment of cheese is subject to the same temperature gradient and thermo-conductive cooling affect.

Step 1 may further occur in a dry environment wherein the stretching auger is heated to maintain the cheese in contact in a heated state. Steps 1, 2 or 3 need not necessarily require a dry type of heat and may utilize hot water according to traditional methods. If the intent is to season the cheese mass at its nascent phase, a method for dry texturizing would be ideal to evenly mix the seasoning in without diluting flavor or salt content.

According to Step 4, the nascent cheese mass is guided towards a series of narrow compressional channels of the counter-rotating dual compressional belt system. Each compression channel having an open first end (or alternatively referred to as its proximal end) for receiving and capturing the warm cheese mass and a second end (or alternatively referred to as its open distal end) for releasing the formed cheese ribbons. Each channel is enclosed on all sides other than the proximal and distal ends, forming a narrow internal compression channel. The internal compression channel may have any type of cross sectional shape that enables a consistent shaping and molding effect while the cheese mass is gradually pulled through. The negative space may be narrow at one or more location along the length of each elongated channel to create pressure points for stretching the cheese as it passes. Preferably, a narrow tapering would exist at the starting proximate end of the belt system to produce an initial squeezing and pulling effect. The side walls of each elongated channel are thermally conductive. The difference in temperature between the external environment and the internal cavity defines a preferred thermal gradient. The thermally conductive side walls being in contact with the cheese on the inside and a cooling medium on the external side facilitate heat exchange between the walls. The cheese may avoid direct contact with the cooling medium in this particular scenario.

Each belt of the two counter-rotating dual belt device comprising a circular loop of flexible thermo-conductive material, wrapping around at least two rotating drive mechanisms forming one half of a counter rotating dual belt drive system. Each belt is preferably comprised of a solid, durable (having minimal stretch), flexible, non-flaking food grade material for purposes of cheese molding and food handling. Each belt should hold its grip over the cheese through the entire length of the compression channel. The rate of speed of each rotating belt is adjustable by adjusting the rate of speed of the rotating drive mechanisms. The rotating drive mechanisms containing an actuating mechanism comprising manual, electro-mechanical, electro-magnetic or computer means.

A cooling mechanism is in immediate contact with the channel's external side walls. The cooling mechanism may comprise a cooling medium of any combination of solid, liquid or gaseous medium or a thermal conductive container containing and facilitating a constant flow of the cooling medium. Said container may comprise, but is not limited to, the following known devices or techniques such as grooved channeling panels, thermally conductive pipes or tubing that can facilitate heat transfer between its own wall and the walls of the elongated channels. The temperature of the cooling mechanism may be adjusted to be higher or lower than the temperature within the channel cavity. The cooling mechanism may comprise a single continuous piece or alternatively several sectional pieces that couple together along the length of the channel on the external side of the channel wall. This essentially comprises the internal side of each belt that is in contact with the rotating drive mechanism and not in contact with the cheese mass. The cooling mechanism may alternatively comprise super cooled gas or liquid suspended in an open environment directly contacting the channel side walls (not in contact with the internal compression cavity). In any case, any known manner in the art for creating a temperature gradient between the channel's internal cavity and immediate external environment may be embodied in this invention to accomplish cooling by thermal conductive heat transfer through the channel wall.

Proper setting of the cheese ribbons will depend on period of exposure between the cheese surface and the cooling walls of the elongated channels. Setting time is further dependent on the temperature gradient between the cheese and the external environment and the amount of cheese surface area in contact with the cooling side walls. Ultimately, the rate of speed in which the cheese ribbons are pulled through relative to the length of each channel will determine the period of exposure. The channels may be adjusted in length and the rotating pulling belts may be adjusted for speed to establish a preferred period of exposure of the cheese to the cooling environment. Multiple cooling mechanisms attached along segments of the compression channel renews the cold temperature within the internal cavity of the compression channel, managing a more efficient cooling effect over the surface area of the cheese for the length of the channel.

Preliminary tests of this inventive subject matter using the preferred embodiment discussed below as described in detail reveal significant improvement in the cooling and molding process. A nascent warm pliable cheese mass was placed in the trough and pulled through a ⅝″× by 4″ rectangular cavity opening. The cooling mechanism facilitated a continual flow of 54° F. water. The initial temperature of the warm cheese mass at the start was 144° F. Within minutes after pulling the cheese from proximal end to distal end, the internal core temperature of the ⅝″ by 4″ thick cheese ribbon reached 83° F. and the cheese became self supporting. The flavor of the final cheese product did not change despite the cooling and molding process. The cheese mass and ribbon never came in direct contact with the cooling medium throughout the length of the channel. The final product contained sufficient density of cheese fibers when torn apart by hand, evidencing effective stretching of the cheese mass within the channels.

By pulling the warm cheese through the counter-rotating dual compression belt channels, the cheese is continuously and concurrently stretched, shaped, and cooled to set within the length of each enclosed channels in relatively short time. The continuous and concurrent nature of this technique allows for constant production of high quality cheese with minimal space requirement and without need for liquid. The ability to produce cheese free of liquid allows the cheese to be dry salted at the start of the process since there would not be a risk of dilution from submersion in hot water bath. The ability to avoid liquid cooling towards the end of this process is a second necessary condition to enable dry salting to occur. Since the cheese would not have to be cooled in a brine bath, it would not otherwise be oversalted by seasoning at the beginning and end phases. Cooling by thermal conductive heat transfer eliminates the need for separately cooling and molding, eliminating the brining process entirely. As such, a novel technique for high volume production of cheese of hand crafted quality is established herein.

Another embodiment of this invention provides for a series of compression channels or chambers fluidly connected to the distal ends of the elongated channels described above. Ribbons of cooled and set cheese released from the elongated channels are guided towards the proximal ends of the compression channels by a guiding mechanism. Multiple cheese ribbons enter each compression channel where they are pulled through with a pulling mechanism and compressed to laminate at narrow portions within the internal cavity of each compression channel. The compression channels are completely enclosed on all sides, other than the proximal and distal ends, to form an internal cavity with a negative space of defined shape and dimension. The cross sectional space of the internal cavity at one or more location being narrower than the perimeter of the several cheese strips combined for purpose of compression and lamination. The negative space within the compression channels is continuous from the proximal end to the distal end. Each compression channel having pulling mechanisms and cooling mechanisms of the same or similar construction and functionality as described above for the elongated channels. As described above for the elongated channels, the side walls of the compression channels may also be thermally conductive and in contact with a cooling mechanism on its external side. However, cooling may not be required at this stage of molding and its absence in the compression channels may be an alternate embodiment to this invention.

As the cheese ribbons are pulled through each compression channel, they are compressed and laminated together to form a larger ribbon of cheese with defined shape. The core temperature of the larger laminate ribbon is equivalent to or lower than the core temperature of the individual cheese ribbons released from the distal end of the elongated channels. As in the preliminary test discussed above, the core temperature of a standard sized block that is approximately 2 inches wide by 4 inches long, cooled at 54° F. along the length of the elongated channel may decrease to 83° F. or lower after release from the compression channels. This alternative embodiment is ideal for continuous production of industry standard large sized cheese products or blocks. Note that nearly any desirable cross sectional shape and size may be achieved by the above described process of this invention.

Other features, advantages, and object of the present invention will become more apparent and be more readily understood from the following detailed description, which should be read in conjunction with the accompanying drawings.

### BRIEF DESCRIPTION OF THE DRAWINGS

FIG. 1A is a plan view cross sectional thermal profile of a cheese block illustrating cooling efficiency problems within the current art.

FIG. 1B is a plan view cross sectional thermal profile of three laminated cheese ribbons in accordance with an embodiment of the present invention.

FIG. 2A is a plan view of the inventive subject matter in accordance with an embodiment of the present invention.

FIG. 2B is a plan view of a serpentine panel in accordance with an embodiment of the present invention.

FIG. 3 is an exploded three dimensional top and front side view of the compression channel in fluid connection with the distal ends of the elongated channels in accordance with an embodiment of the present invention.

### DETAILED DESCRIPTION OF THE PREFERRED EMBODIMENTS

Reference will now be made in detail to exemplary aspects of the present invention which are illustrated in the accompanying drawings. Wherever possible, the same reference numbers will be used throughout the drawings to refer to the same or like parts.

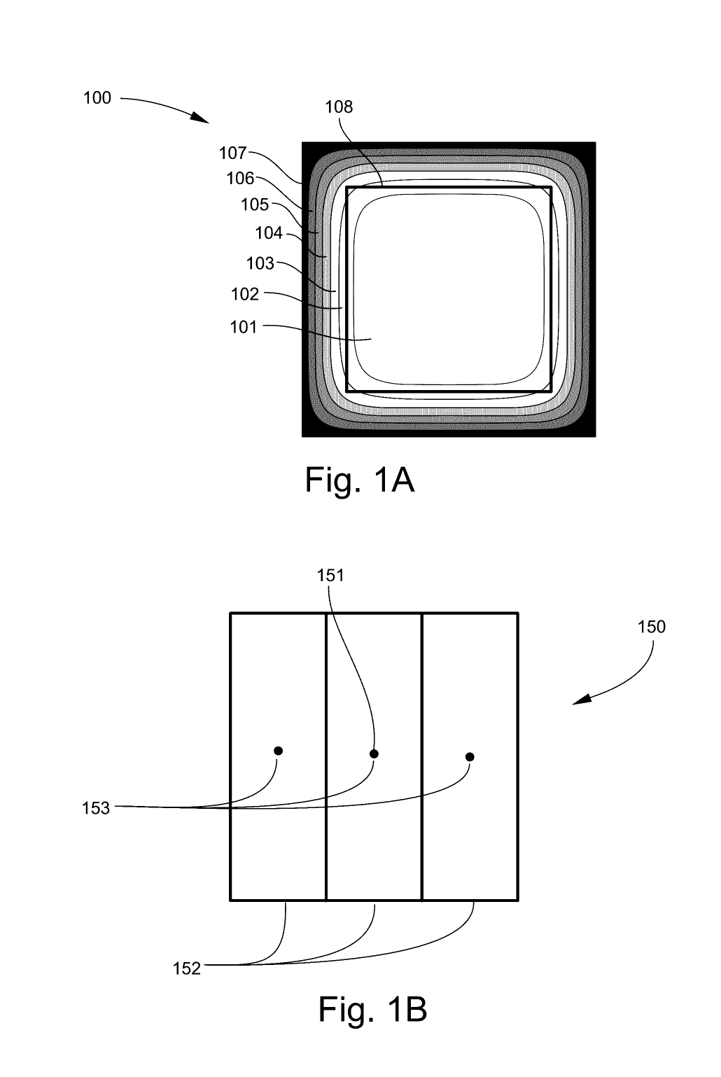

FIG. 1A is an illustration of a theoretical transient heat transfer study of cheese illustrating a cross sectional temperature profile for a standard 4×4 inch six pound block 100 of cheese submersed in 32° F. brine solution for 10 minutes. The calculations were based on thermal conductivity of 0.332 W/mK and specific heat of 3 kJ/kgK. The theoretical heat study revealed a temperature profile for seven external cross sectional layers (⅝ inch thick each) surrounding a thicker inner core of a 4×4 inch cheese block 100. The profile shows seven temperature ranges (rounded to the nearest degree) from inner core to outer surface on a per layer basis: 1) 140° F. to 125° F. (101), 2) 125° F. to 109° F. (102), 3) 109° F. to 94° F. (103), 4) 94° F. to 78° F. (104), 5) 78° F. to 63° F. (105), 6) 63° F. to 47° F. (106), 7) 47° F. to 32° F. (107). The outside “skin” 107 (according to the study, being the outermost layer in contact with the external environment) is able to cool from an initial temperature of 140° F. to 32° F. within 10 minutes of submersion in 32° F. brine solution while the inner cross sectional half of the cheese block mass (illustrated by the dark line 108) requires at least 4 to 5 additional hours to cool to set. In contrast, FIG. 1B shows a cross sectional profile of three cheese ribbons 152 (each ⅝ inch by 4 inches in dimension) laminated together 150 to form a larger ribbon of approximately 2 inches wide by 4 inches long. The core temperature 151 of the larger ribbon 150 is equal to or lower than the core temperatures 153 of each single ribbon composites 152. For my preliminary study, when exposing the singular ribbons 152 of mozzarella cheese to a constant cooling temperature of 54° F. while being pulled through the elongated compression channels, the core temperature cooled to approximately 84° F. within minutes as it reached the proximate ends of the compression channels. The core temperature 151 of the final laminated block 150 was also approximately 84° F., ready for immediate packaging without need for further cooling.

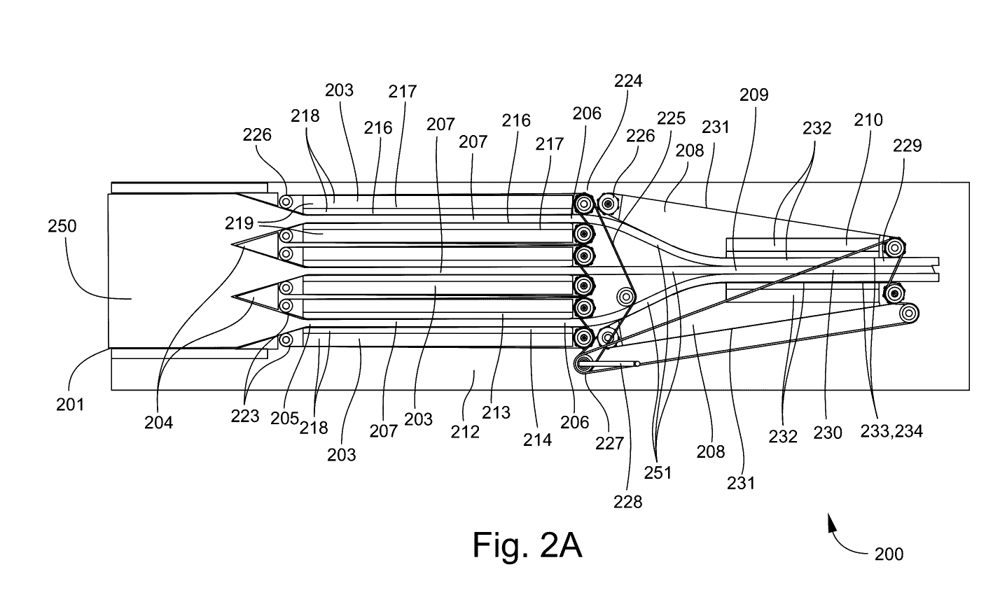

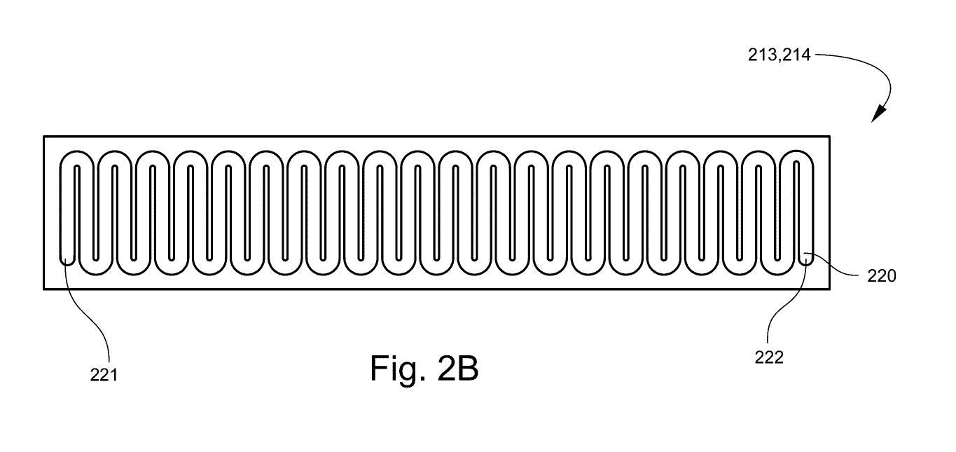

FIG. 2A is an illustration of an exemplary embodiment of the inventive subject matter 200. This embodiment having a receiving chamber 201 or a trough for receiving the nascent warm cheese 250, a series of three elongated compression channels 203 and several guiding means 204 located between the trough 201 and the proximal end 205 of said elongated compression channels. Alternate embodiments of the invention may have fewer or greater numbers of elongated compression channels within each series than is depicted herein. The image of the elongated compression channels 203 of FIG. 2A does not provide for an accurate depiction of length but suggests only a length sufficient to accomplish the purpose of said invention. The length of each compression channel 203 may be adjustable to the user's preference. Each elongated compression channel may comprise one single or multiple individual segments. Each individual segment having a set of two flexible thermo-conductive belt loops, each belt loop in contact with at least two rotating driving mechanisms such that the two belt loops counter rotate against each other, forming a compression cavity therebetween where cheese is captured, compressed and pulled through. The guiding means 204 may also vary in quantity, shape and positional placement, depending on the action it is intended to achieve. In the immediate embodiment of FIG. 2A, the guiding means 204 comprises a simple triangular shaped immobile wedge seated on the proximal side of the channel opening 205, for the purpose of guiding and portioning (via the sharper protruding edge) the nascent cheese mass 250 into the compression channel cavities 207. In contrast, the guiding means 208 located beyond the distal end 206 of said elongated compression channels 203 in the preferred embodiment of FIG. 2A having rounded edges and integrated together within the proximal end 209 of the compression channel 210 purely for the purpose of corralling and guiding the long cheese ribbons 251 released from the elongated compression channels 203 without causing dent to the final cheese shape.

According to the embodiment of FIG. 2A, each elongated compression channel 203 is open on the proximal end 205 to receive the cheese mass and the distal end 206 to release formed and cooled cheese ribbons 251. Each elongated channel 203 is covered on all other sides by contiguous side walls (referred to cumulatively as the side walls 215, shown in part herein the bottom 212, left 213 and right 214 sides, top side not shown) to form an enclosed narrow internal cavity 207. The enclosed narrow internal cavity comprises a negative space of defined cross sectional shape and surface area (not shown). According to the embodiment of FIG. 2A, the side walls may form a rectangular or square shaped negative space. Alternate embodiments of the elongated compression channels 203 may have narrow internal cavities 207 and negative spaces of nearly any cross-sectional shape. The narrow internal cavity 207 may be shaped to be narrower at certain locations along the length of the channels to create additional pressure points for stretching the cheese.

The side walls 215 of each channel illustrated in FIG. 2A includes a top (not shown), bottom 212, right 214 and left side 213 surfaces. The bottom side wall in this particular embodiment comprises a large flat surface 212 that seats the entire device, creating a tight sealed connection with the left 213 and right side 214 walls of the elongated compression channels (among other parts of the device), thus acting dually as the bottom side wall 212 to the channels of the device. Again, alternate embodiments of this invention may have just one continuous side wall, particularly if the internal cavity is circular or oval with no corners or angles. In the depicted embodiment of FIG. 2A, the top wall surface may be a simple flat top cover, such as but not limited to glass, food grade plastic, or food grade metal, forming a fluid connection with the channel's right 214 and left 213 side walls. The bottom side 212 wall may be a simple base surface composed of the same food grade material as the rest of the compression channel side walls 215, fluidly connected to the compression channel's left 213 and right 214 walls. The left 213 and right side 214 walls comprising each of the two counter-rotating dual compression belts. The material composition of the compression channel side walls 215 is preferably food grade, solid, nonporous and non-flaking. Further, one or more side walls 215 should be thermally conductive and have the same level of thermal conductivity as the cheese mass.

The side walls 215 of each elongated compression channel 203 have an internal side facing 216 the internal cavity 207 and an external side facing the external environment, opposite the internal cavity 207. The external side of the top side wall (not shown) of FIG. 2A faces the top ambient environment. The external side of the bottom side wall 212 of FIG. 2 faces the bottom ambient environment, assuming the device is positioned above ground level. The external sides 217 of the right 214 and left 213 side walls of FIG. 2A faces a series of cooling mechanisms 218 that facilitate continuous flow of a cooling medium (not shown). The cooling mechanism 218 comprises a cooling block 219 of similar dimensions as the channel side walls 215, receiving water through a piping system (not shown) and facilitates a flow of cold medium. The cold medium may comprise any combination of solid, liquid and or gas. In the embodiment of FIG. 2A and the exploded view of 2B, the external side of the compression channel's left and right side walls 213, 214 further possess grooved serpentine channels 220. The serpentine channels are exposed on the external side facing the cooling block 219. When pressed against each other, the cooling block 219 and the serpentine channels 220 of the channel's external side walls 213,214 form a water tight seal. Cold water received from a piping system through the cooling block is directed into one end 221 of the serpentine channels and out of the other end 222 of the serpentine channels where the water is recalibrated to the desired temperature at the originating source. The continuous flow of cooling medium against the compression channel side walls 213, 214 helps to maintain a constant temperature gradient for purposes of efficient cooling inside the channel cavity. The serpentine channels 220 may alternatively be incorporated into the cooling block 219 to achieve essential the same results, which is the facilitation of cold medium against the external surface 217 of the compression channel side walls 213, 214. The cooling mechanism 218 may alternatively comprise a series of tubing carrying chilled medium, where the tubing wall is in contact with the channel external side walls 217. In such instance, the tubing wall (not shown) should be highly thermal conductive to ensure optimum heat transfer between the chilling medium and channel's internal cavity 207 through two layers of walls (the tubing wall and the channel wall).

The channel side walls may be further composed of either multiple serpentine channel panels (see FIG. 2B) interconnected together to form a desired length of elongated compression channel 203 or simply one single panel of a desired length. In either case, the user should be able to vary the temperature settings at different locations along the channel length. The cooling mechanism 218 in generally should also be comprised of solid, nonporous, food grade material that is thermally conductive, preferably at the same level of thermal conductivity as the cheese mass.

According to the preferred embodiment of FIG. 2A, a cooling temperature gradient is created between the external side 217 and internal side 216 of each compression channel side wall. As the cheese 250 passes through the length of each compression channel's internal cavity 207, it is quickly cooled. Given the wide surface area of the cheese ribbons 251 that is in direct contact with the compression channel's cool internal walls 216, the external and internal cross sectional layers of the cheese ribbons 251 quickly cool to setting temperatures. The rate of cooling will depend on period of exposure of cheese ribbons of a given cross sectional size to a preferred temperature gradient. The period of exposure is further dependant on the rate of speed in which the cheese ribbon is pulled through each compression channel and the length of the compression channel itself. Thus the dimensions of the compression channels should be adjustable to accommodate and control cooling time.

As stated above, the left 213 and right 214 side walls may themselves comprise each of the two counter-rotating dual compression belts which make up the pulling mechanism. Alternatively, the pulling mechanism may slidaby rest over any two opposing side wall of the four side walls, utilizing the side walls as guide and structural support. The preferred embodiment of FIG. 2A depicts an internal cavity 207 in contact with a pulling mechanism that follows the length of each compression channel 203, moving continuously alongside the internal walls 216 from proximal end 205 to distal end 206. The pulling mechanism may comprise any known means for gripping onto soft pliable and elastic material of varying levels of moisture that is also large in mass and volume. The preferred pulling mechanism would be able to quickly grip onto a portion of said cheese mass and pull the mass directly into and through the length of each channel's internal cavity 207 from proximal end 205 to distal end 206. The pulling mechanism 223 of the preferred embodiment of FIG. 2A comprises one or more rotating belts 223 looped around each elongated channel 203 from proximal 205 to distal ends 206 through the internal cavities 207 of each channel. The belts of the pulling mechanism depicted in FIG. 2A are pulled forward from proximal 205 to distal end 206 in continuous motion by a cog belt system 224. The cog belt system comprises just one of many known and standard actuating means that can activate the pulling mechanism in the manner intended herein. In the device illustrated in FIG. 2A, SS belts 225 are looped over a series of cog wheels 226. Several of said cog 226 wheels strategically positioned at the proximal and distal ends of the elongated channels and compression channels where the rotating belts 223 of the pulling mechanism are dually looped around and below the SS belts 225. Rotation of a central cog wheel 227 (by hand lever 228 or motor drive, etc.) where the SS belts 225 converge results in rotation of the entire SS belt system 225, forcing directional movement of the cog wheels 226 and in turn, resulting in tandem rotation of the rotating belts 223 of the pulling mechanism. The actuating means may further control the rate of speed in which the pulling mechanism moves, controlling the degree of stretching at pressure points along the internal cavity 207 of the channels 203. As stated above, the left 213 and right 214 side walls may themselves comprise each of the two counter-rotating dual compression belts which make up the pulling mechanism. Alternatively, the pulling mechanism may slidaby rest over any two opposing side wall of the four side walls, utilizing the side walls as guide and structural support.

The rotating belts 223 in general should be thermally conductive. The belts 223 are in direct contact with the compression channels' 203 inside cavity wall 216 and the cheese mass 250, 251 and ribbons. As the cheese is pulled through the length of each channel cavity 207, filling said cavity 207, it is molded to the shape of the negative space. The belt 223 should hold its grip over the cheese mass 250 and ultimately the cheese ribbon 251 through the entire length of each channel 203. The belts 223 are preferably comprised of a solid, flexible, durable, non-stretching and non-flaking food grade material for purposes of cheese molding and food handling.

The distal ends 206 of the elongated compression channels 203 in the preferred embodiment of FIG. 2A releases ribbons of cheese which are further directed into a second series of compression channels 210, for additional molding via pressing and lamination. The invention may alternatively provide for multiple compression channels 210 in fluid connection in order to achieve the particular manner of manufacture desired. The compression channel 210 of FIG. 2A has elongated guiding means 208 fluidly connected to its proximal end 209, guiding and directing multiple ribbons of cheese 251 towards a narrow compression channel 210. Since the ribbons 251 may have already been cooled to set by this stage, no further cooling may be required but cooling means may be added to the compression channels 210 in the same manner of construction as with the elongated compression channels 203, to achieve specific molding temperatures. The compression channels 210 are completely enclosed on all sides, other than the proximal 209 and distal ends 229, to form an internal cavity 230 with a negative space of defined shape and surface area (not shown). The cross sectional space (not shown) of the internal cavity 230 at one or more location being narrower than the perimeter of the several cheese strips combined for purpose of compression and lamination. The negative space within the compression channels 210 is continuous from the proximal end 209 to the distal end 229. Each compression channel 210 having pulling mechanisms 231 and cooling mechanisms 232 of the same or similar construction and functionality as described above for the elongated channels. In the preferred embodiment of FIG. 2A, the compression chamber side walls (referred to cumulatively as 235, comprising a bottom 212, left 234, right 233, and top not shown) should also be thermally conductive, preferably to the same level of the cheese ribbons. The actuating means for the compression channel 210 as depicted in FIG. 2A is coextensive with that of the elongated channels 203, activated by the same source through interconnected SS belts 225. However, the actuating means need not be coextensive between the two series of channels 203, 210.

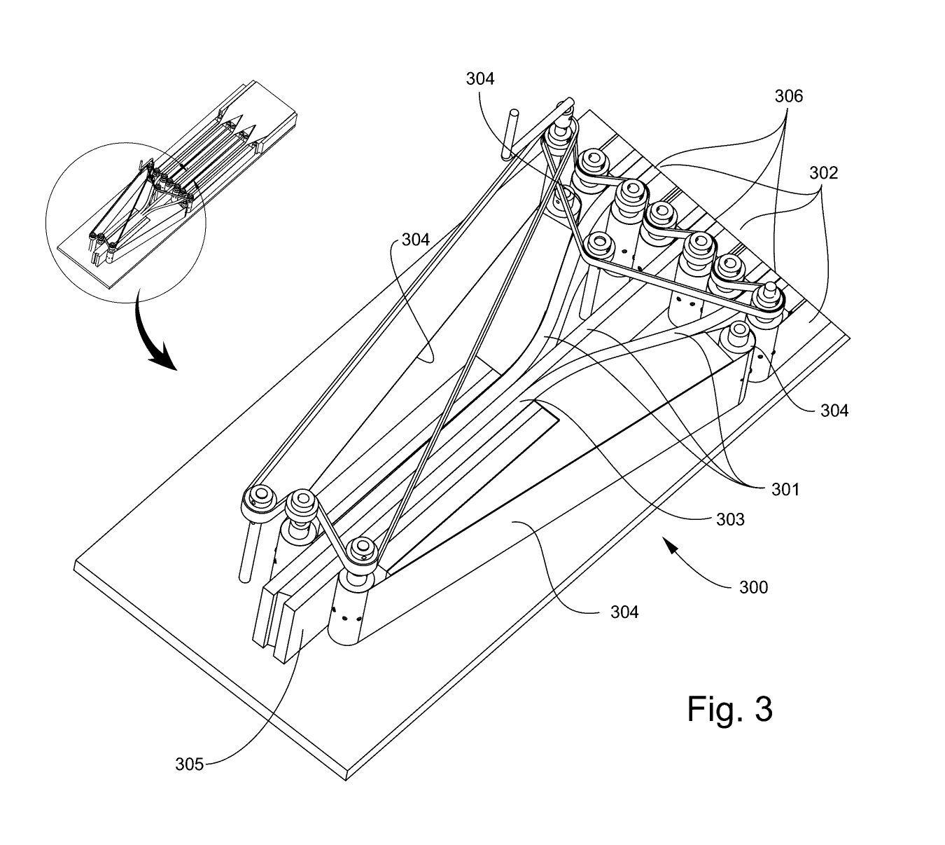

FIG. 3 depicts an exploded view of an exemplary embodiment of the compression channel 300 where cheese ribbons 301 are released from the distal ends 306 of the elongated compression channels 302 pulled into the proximal end of the 303 compression channel 300 by a rotating belts 304 of a pulling mechanism, and are compressed and laminated together to form a larger ribbon 305 of cheese with defined shape. This preferred embodiment is ideal for producing continuous cheese ribbons easily cut to industry standard sized cheese blocks. However, nearly any desirable cross sectional shape and sized may be achieved through the combination of processes of the described invention.

Having fully described at least one embodiment of the present invention, other equivalent or alternative methods according to the present invention will be apparent to those skilled in the art. The invention has been described by way of summary, detailed description and illustration. The specific embodiments disclosed in the above drawings are not intended to be limiting. Implementations of the present invention with various different configurations are contemplated as within the scope of the present invention. The invention is thus to cover all modifications, equivalents, and alternatives falling within the spirit and scope of the following claims.

What is claimed is:

1: A system for forming artisanal style pasta filata cheese by a non-brining method wherein a warm pliable cheese mass is concurrently pulled to stretched, molded and cooled to set through a counter-rotating dual compression belt device forming a continuous ribbon of pasta filata cheese,
said counter-rotating dual compression belt device comprising two sets of rotating belts, each set of rotating belt comprising a thin flexible sheet of food grade belt material encircling two or more rollers attached to a drive mechanism,
each set of rotating belt in counter-rotation with the other,
said two sets of rotating belts in perpendicular connection with two planar rigid side walls such that a narrow compression channel is formed between the first and second set of rotating belt,
said narrow compression channel in external communication with a thermos-conductive cooling means,
said narrow compression channel having a first proximal end where the nascent pasta filata cheese is received and pulled through,
said narrow compression channel having a second distal end where the nascent pasta filata cheese is released in molded and set condition.

2: The system for forming artisanal style pasta filata cheese of claim 1 wherein said cheese is cooled by thermal heat transfer between the walls of said narrow compression channels.

3: The system for forming artisanal style pasta filata cheese of claim 1 wherein said narrow compression channel comprising an angular or rounded cross sectional shape.

4: The system for forming artisanal style pasta filata cheese of claim 1 comprising a secondary segment of counter-rotating dual compression belt device for receiving multiple cooled ribbons of pasta filata cheese from a first counter-rotating dual compression belt device wherein said multiple cooled ribbons of pasta filata cheese are laminated within said secondary segment of counter-rotating dual compression belt device.

5: A method for creating large cheese ribbons of a desired shape in which a series of small cheese ribbons already stretched, molded and cooled to set are guided into one or more compression channels, the small ribbons being compressed and laminated together within said compression channels to form a larger cheese ribbon of a preferred shape.

6: A counter-rotating dual compression belt device for forming artisanal style pasta filata cheese wherein said counter-rotating dual compression belt device comprising two sets of rotating belts,
each set of rotating belt comprising a thin flexible sheet of food grade belt material encircling two or more rollers attached to a drive mechanism,
each set of rotating belt in counter-rotation with the other,
said two sets of rotating belts in perpendicular connection with two planar rigid side walls such that a narrow compression channel is formed between the first and second set of rotating belt,
said narrow compression channel in external communication with a thermos-conductive cooling means,
said narrow compression channel having a first proximal end for receiving a pliable cheese mass,
said narrow compression channel having a second distal end for releasing continuous ribbon of molded and cooled pasta filata cheese.
